(19) United States
(12) Patent Application Publication
(10) Pub. No.: US 2002/0073331 A1
(43) Pub. Date: Jun. 13, 2002

(54) Interacting automatically with a personal service device to customize services

(76) Inventor: Brant Candelore, Escondido, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/974,151

(22) Filed: Oct. 9, 2001

Related U.S. Application Data
(60) Provisional application No. 60/254,502, filed on Dec. 8, 2000.

(51) Int. Cl. G06F 12/14

(52) U.S. Cl. 713/200

(57) ABSTRACT

A personal service device automatically queries a user device in response to discovering the user device and receives data from the user device that is used to customize a service provided through the personal service device. The service may be customized at the personal service device or at a server. Access to the data may be restricted to only personal service devices with proper authorization. Data from multiple devices is combined and conflict resolution is performed when the data from multiple devices conflict.

### RELATED APPLICATIONS

This application claims the benefit of U.S. Provisional Application Serial No. 60/254,502 filed on Dec. 8, 2000. The provisional application is hereby incorporated by reference into the present application.

### BACKGROUND OF THE INVENTION

1. Field of the Invention

The present invention relates to interacting automatically with a user device in general, and to querying the user device to deliver customized services to a user in particular.

2. Art Background

Typically, a cable subscriber must program a list of favorite locations, programs, and channels into his television or set-top box to have a customized program guide. This programming process can be time consuming and tedious. Instead, some cable systems implement a user login process. Although this can allow the user to receive customized programming and customized web pages with targeted advertisements, the login process itself can be tedious. Thus, the user or viewer is apt to skip over the login process, leaving it in a default state and thereby defeating the purpose of the login, which is to determine precisely who the program viewer is. In the absence of a customization scheme, advertisements are broadcast generically and indiscriminately without regard for the viewer's interest.

There is therefore a need for performing an automatic query of user preferences for the delivery of customized services to a user.

### SUMMARY OF THE INVENTION

A personal service device automatically queries a user device in response to discovering the user device and receives data from the user device that is used to customize a service provided through the personal service device. The service may be customized at the personal service device or at a server. Access to the data may be restricted to only personal service devices with proper authorization. Data from multiple devices is combined and conflict resolution is performed when the data from multiple devices conflict.

### BRIEF DESCRIPTION OF THE DRAWINGS

The present invention is illustrated by way of example and not limitation in the figures of the accompanying drawings in which like references indicate similar elements.

FIG. 1 is a block diagram illustrating operations of a user device and a personal service device operating according to one embodiment of the invention.

FIGS. 2-4 are block diagrams of various security components interacting with the user device and the personal service device of FIG. 1.

FIGS. 5-8 is flow diagrams of methods executed by the user device and the personal service device to perform the operations of FIG. 1.

FIG. 9 is a simplified block diagram of one embodiment of a secure transaction system.

FIG. 10 is a simplified block diagram of one embodiment of a privacy card for a personal transaction device.

FIG. 11 is a simplified block diagram of one embodiment of a digital wallet for a personal transaction device.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that functional, logical, mechanical, electrical and other changes may be made without departing from the scope of the present invention. The following detailed description is, therefore, not to be taken in a limiting sense, and the scope of the present invention is defined only by the appended claims.

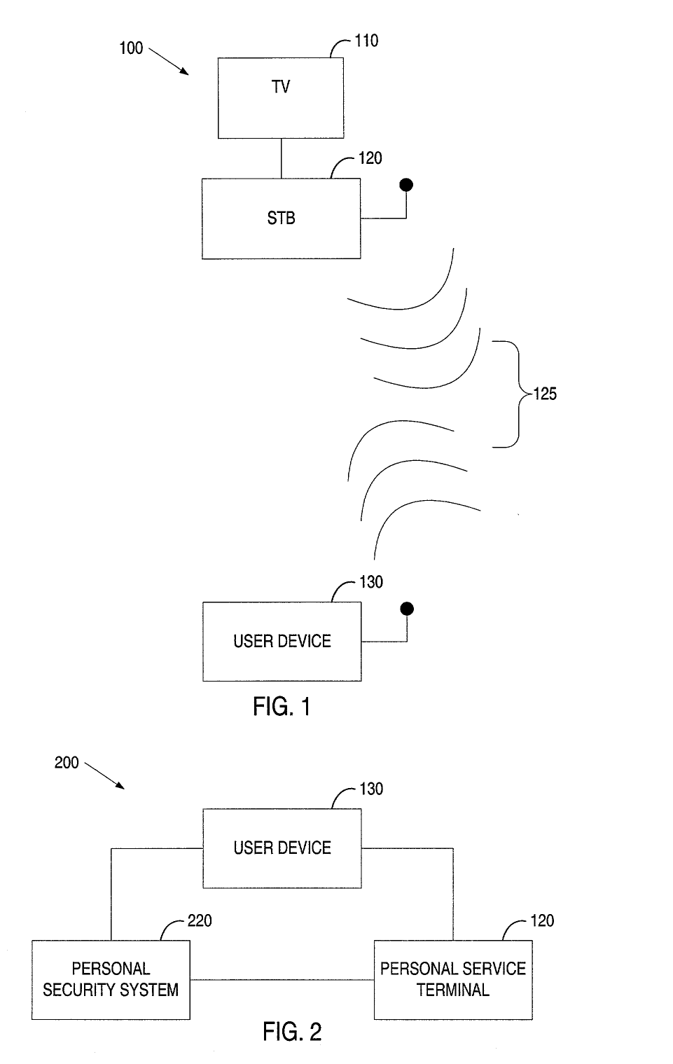

FIG. 1 is a block diagram of one embodiment of communication between a personal service device (PSD) 120, illustrated as a set top box, and a user device 130. The personal service device 120 is a local media, communication, or other type of device capable of communicating with the user device 130, such as a television (TV), a set-top box (STB), a headend, a stereo, a game console, and a computer, but the invention is not so limited. In the embodiment of FIG. 1, the set-top box is any electronic device designed to produce output on a conventional television set, such as TV 110, and is further connected to other communications channels such as telephone, ISDN, optical fiber, or cable. The STB usually runs software to allow the user to interact with the programs shown on the television in some way. When the STB is part of a cable television system, it is coupled to a headend (not shown), which is the electronic equipment located at the source of the cable television system, and typically includes antennas, earth stations, preamplifiers, frequency converters, demodulators, modulators, and related equipment. STBs and TVs in cable systems typically have a back channel or RF path in which the data can be sent to the headend.

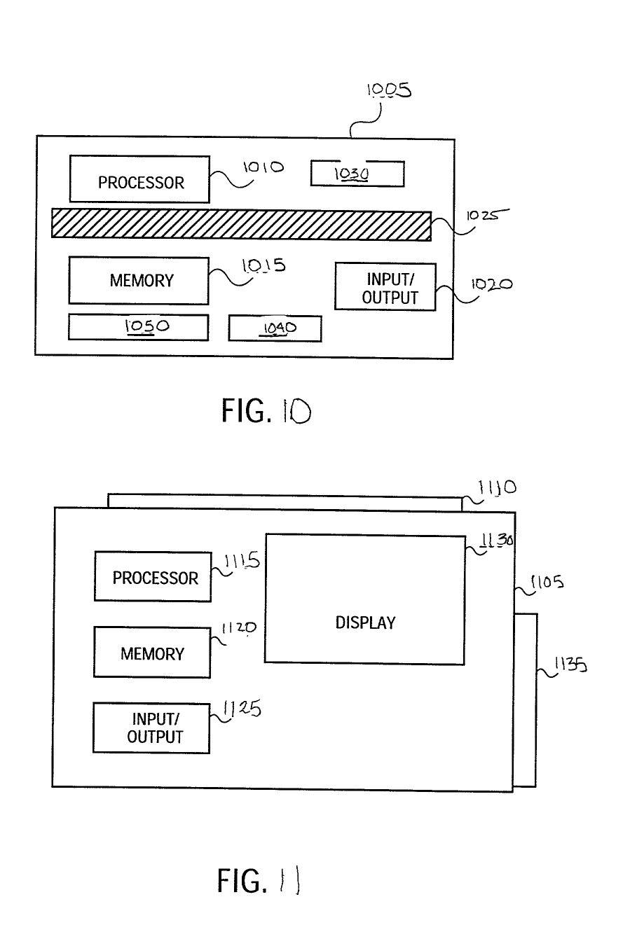

The user device 130 may be a personal transaction device (PTD), such as a portable consumer device for assisting with provision of goods and services to a user. A PTD includes a digital wallet (DW), a privacy card, and a personal digital assistant (PDA), such as described further below with reference to FIGS. 10 and 11, but the invention is not so limited. Furthermore, the user device 130 may be secured against unauthorized use through one of several security mechanisms described in conjunction with FIGS. 10 and 11.

Communication between the user device 130 and the PSD 120 take place over a wireless communication link 125, which may be RF, infrared, Bluetooth, or other suitable technology.

As shown in FIG. 1, the PSD 120 periodically seeks for user devices within a scanning range of the PSD 120 using a device locator signal. If a user device 130 is present, it sends an identification signal containing a device identifier (DI) to PSD 120 in response to the device locator signal. If the PSD 120 recognizes the DI, it has already received the user information from a previous seek. If the PSD 120 does not recognize the user device, the user device is considered “newly discovered” and is queried to obtain user information to personalize services provided through the PSD 120. The PSD 120 may recognize a DI using a list of previously discovered DIs stored in memory. The DI may provide no apparent identification of the user of the user device to preserve the privacy of the user. In an alternate embodiment, the PSD 120 queries all user devices within range without attempting to recognize them. In still another embodiment, the user device 130 signals its presence to the PSD 120 by sending the DI without receiving a device locator signal.

The user information is transferred from the user device 130 in response to the query without any involvement by the user. The PSD 120 processes the user information it receives from user device 130 and delivers the appropriately customized service.

In another embodiment, if more than one user device 130 is within scanning range of PSD 120, the PSD 120 attempts to merge the user information received from the multiple users to customize the services. Where a contradiction exists between the preferences of different users, the PSD 120 may perform a manual query of each user asking him to select an option for a customized service to be delivered. Alternatively, the PSD 120 can implement the most restrictive option available to the given group of users. For example, in the case of media content preferences, the most restrictive option might prevent viewing of adult programming.

The user information may include: a user identity, a media content preference, a shopping preference, or personal data. A user identity can be used to draw from a pre-existing user profile stored in, or accessible by, the PSD 120. Media content preferences can be used to present a suitable media program guide to a user. Shopping preferences can be used to present advertisements of interest. Personal data can be used to filter content or advertisements based upon various types of algorithms, such as heuristic algorithms that use subjective knowledge and hunches. The user information is stored as data elements within a user information data structure, which may be located in the user device or accessed from a remote storage location by the user device in response to the query from the PSD 120.

Access to the user information may be subject to security restrictions as described next in conjunction with FIGS. 2-4. The security restrictions are predicated on a user information data structure having various data levels. Each data level may contain a different type of data (such as, clothing sizes, or bank account information) and may have a different level of security restriction, for example, a television acting as PSD 120 might have access to television preferences but not bank account information. Further, each data level may include one or more data elements containing user information.

FIG. 2 is a block diagram of a personal security system 220 that secures the user information for the user device 130 from unauthorized access by a PSD 120. Personal security system 220 authorizes transmission of user information requested by the PSD 120 by data level. Data elements from multiple data levels may be authorized for a single query. In one embodiment, the personal security system 220 is a component of user device 130.

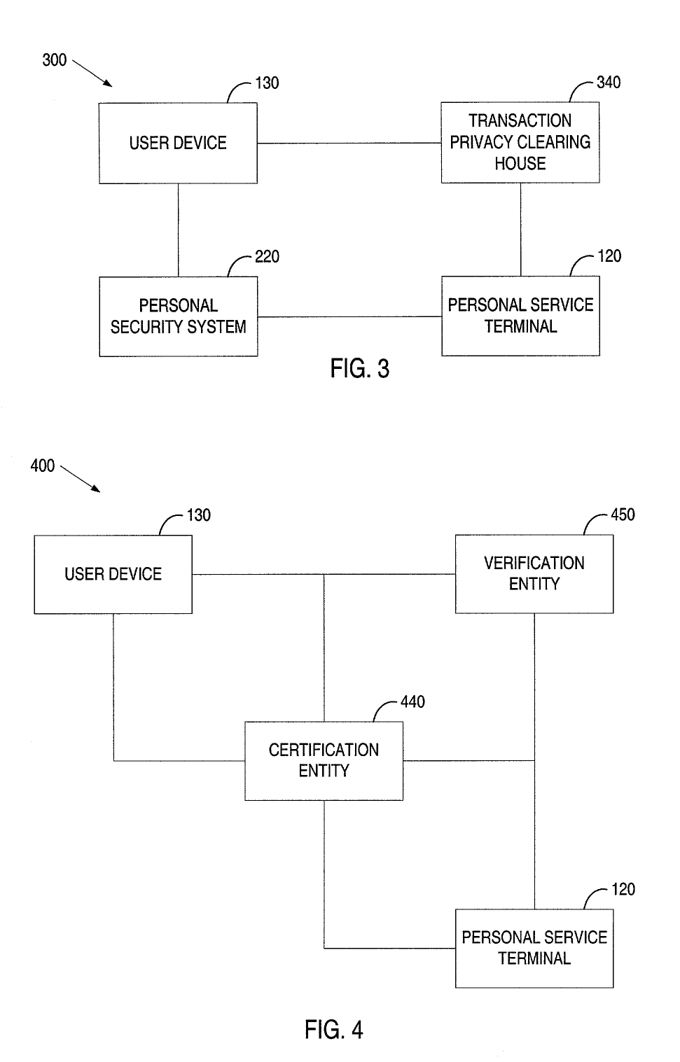

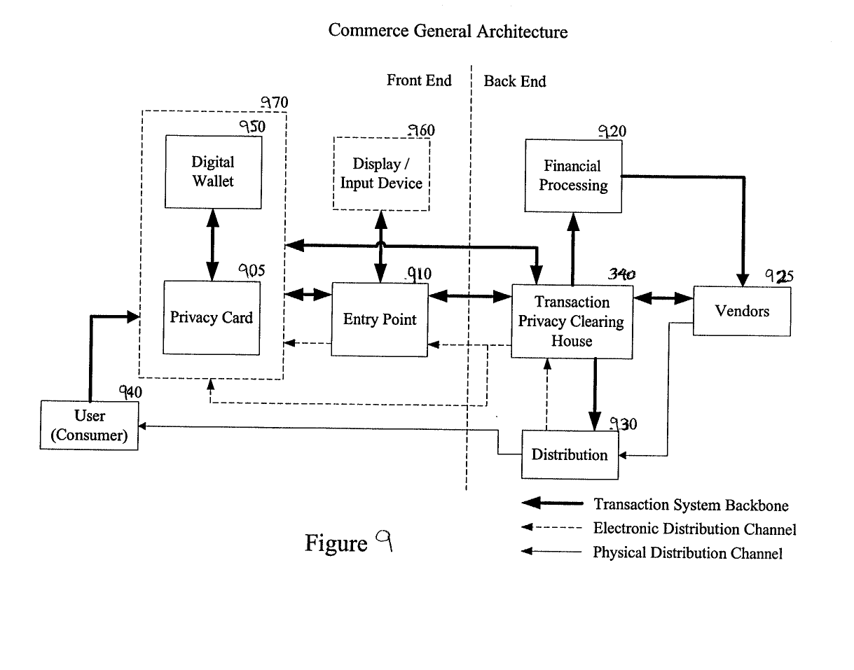

FIG. 3 is a block diagram of a transaction privacy clearing house (TPCH) 340 interacting with the components of FIG. 2. The TPCH 340 protects the privacy of a user as described further below in conjunction with FIG. 9. In the embodiment shown in FIG. 3, the user information data structure is stored at the TPCH 340 and the query from the PSD 120 is authorized by the personal security system 220 before the user information is transferred from the TPCH 340. In one embodiment, the personal security system 220 is a component of the TPCH 340. It will be appreciated that any system external to the user device 130 may perform the operations described above for the TPCH 340 without providing all the privacy features of a TPCH.

FIG. 4 is a block diagram of a certification entity 440 and a verification entity 450 interacting with the personal service terminal 120 and the user device 130 The certification entity 440 creates a credential certificate for PSD 120. The credential certificate authorizes access by the PSD 120 to a given level of data. Verification entity 450 compares the access rights conferred by the credential certificate against the data level of the user information requested by the PSD 120 and authorizes the transmission of the user information to PSD 120 if the access rights are sufficient for the data level. For example, in one embodiment of the credential certificate, a TV or STB would not have access rights to credit card information stored on user device 130, but would have access rights to media and shopping content preferences. Similarly, an Internet clothing store would not have access rights to content preferences, but would have access rights to such information as clothing size, clothing maker preferences and current wardrobe inventory. In one embodiment, the verification entity 450 is a component of user device 130.

Every PSD 120, in yet another embodiment, may be granted access to a “top level” data directory which contains general instructions about the overall structure of the data structure containing the user information. Access to each data level, however, can also be controlled independently. As different levels of the data structure 130 are requested, user device 130 checks the credentials of PSD 120 against the data level of the information requested.

The credential certificate also may contain a public key for the associated PSD 120. As is commonly understood, the public key is the published part of a two-part, public-private key cryptography system. If a query from PSD 120 is encrypted using the private key, the public key in the credential certificate can be used to verify the authenticity of the PSD 120. Furthermore, the user information sent from the user device 130 can be encrypted with the public key in the certificate and only the PSD 120 associated with the certificate will be able to decrypt the information using the corresponding private key.

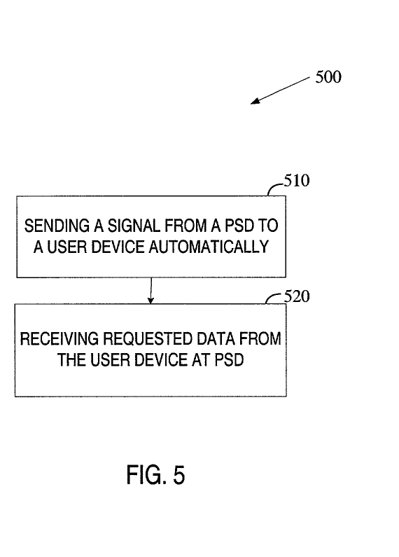

FIG. 5 is a flow diagram of one embodiment of a method executed by a PSD to automatically communicate with a user device to customize services, such as described above in conjunction with FIG. 1. At block 510, the PSD automatically sends a query signal to any user device within range to request user information. At block 520, the PSD receives the requested data from the device.

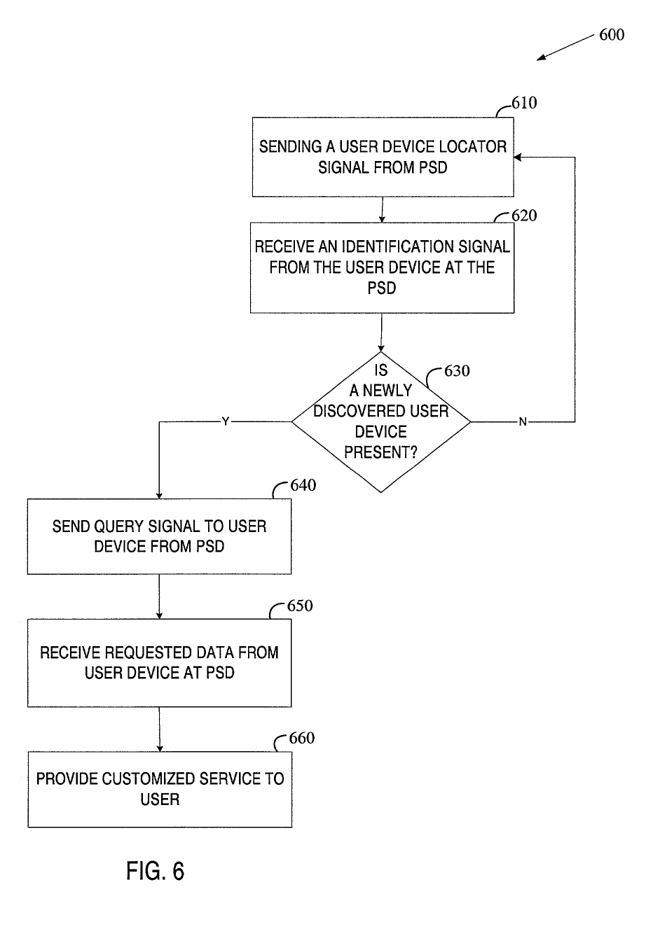

FIG. 6 is a flow diagram of another embodiment of a method executed by a PSD to automatically communicate with a user device to customize services. At block 610, a device locator signal is sent from the PSD to determine whether a user device is in the vicinity of the PSD. At block 620, an identification signal is received from a user device within range. At block 630, a determination is made whether the identification signal corresponds to a newly discovered user device If not, the process returns to block 610. If a user device is a newly discovered, at block 640 a query signal is sent from the PSD to the user device. The PSD receives the requested data from the user device at block 650. At block 660, a customized service is provided to the user, based upon the data received by the PSD.

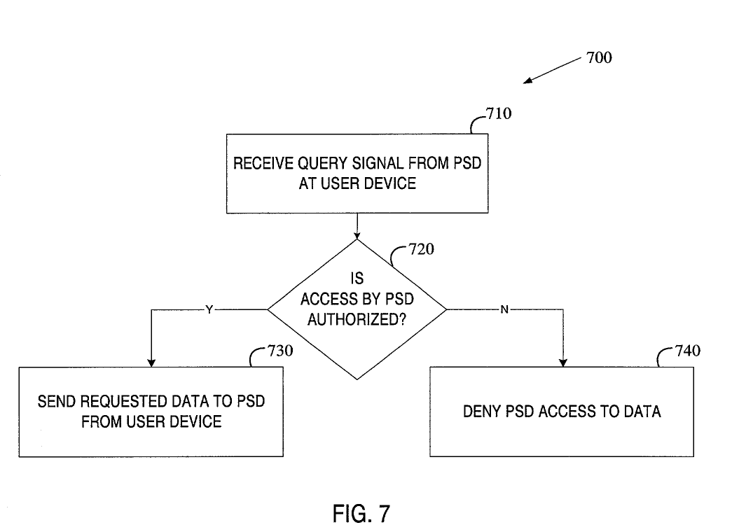

FIG. 7 is a flow diagram of an embodiment of a method executed by the user device to authorize access by the PSD to user information. At block 710, a query signal is received from the PSD at the user device. At block 720, the method determines if the PSD is authorized to access the requested data in the user device. The method may employ security filters, which only allow access to certain levels of data for certain types of PSDs, i.e. a TV would not have access to credit card information, or may check a credential certificate issued by a certifying entity to the PSD that allows access to a specific data level. In one embodiment, the credentials or certificate containing credentials must be found genuine before access is allowed. At block 730, if the access by the PSD is authorized, the requested data is sent to the PSD from the user device. At block 740, access by the PSD to the user device is denied if access by the PSD is not authorized. In one embodiment, an error message is sent from the user device to the PSD if access by the PSD is not authorized.

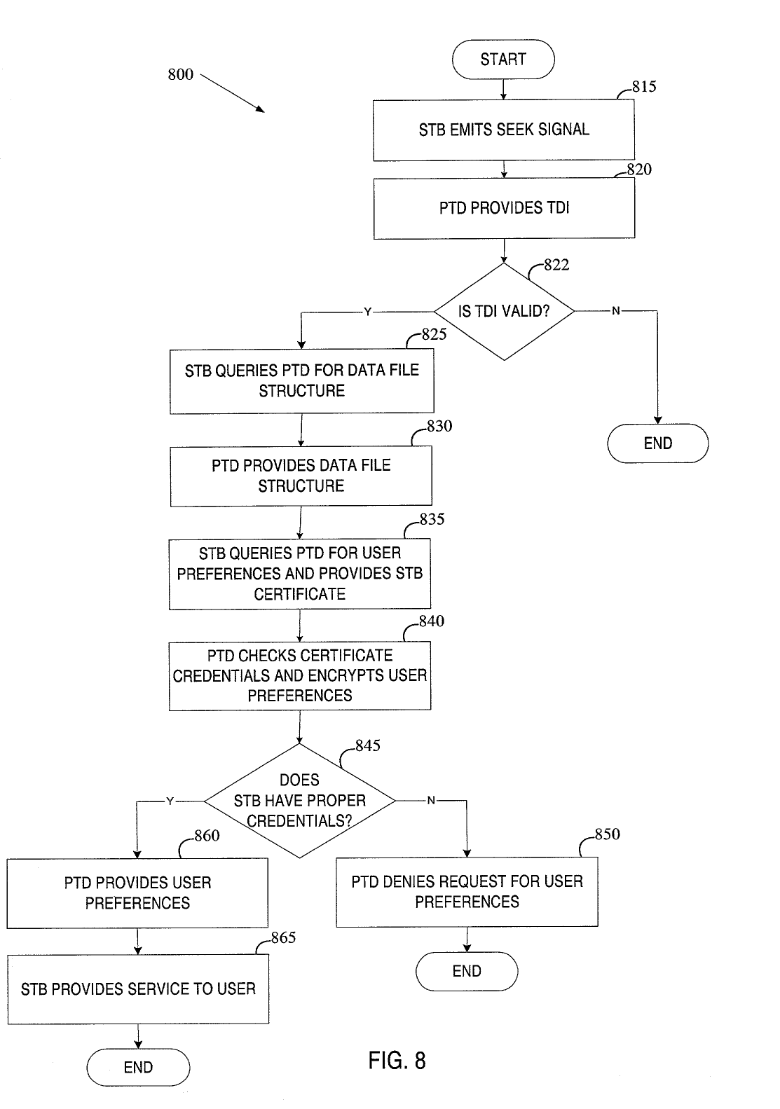

FIG. 8 is a flow diagram of method executed by a personal transaction device (PTD) acting as a user device and a STB acting as the personal service device. At block 815, an STB emits a seek signal to detect user devices within range. At block 820, the user device responds by providing a terminal device identifier (TDI) to the STB. The TDI may associate a particular user to a particular user device. At block 822, the STB checks the validity of the TDI. At block 825, if the TDI is valid, the STB queries the user device for a data directory. At block 830, the user device provides the data directory to the STB. At block 835, the STB queries the user device for user preferences and provides an STB certificate. At block 840, the user device checks the credentials of the certificate for authenticity and may also encrypts the user preferences using the public key of the STB specified in the certificate. At block 845, the method determines if the STB has proper credentials. If not, at block 850, the STB query is denied. If the STB has the proper credentials, at block 860, the user device provides user preferences to the STB, which may be encrypted. At block 865, the STB provides a customized service to a user.

Although the method in FIG. 8 has been described as interacting with only one user device for sake of simplicity, it will be appreciated that when multiple user devices are detected, at block 865 the STB may attempt to harmonize the query results as previously described. If the harmonization fails, the method may request the users manually select a customized service option as part of the processing at block 865.

It will further be appreciated that the methods described in conjunction with FIGS. 5-8 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result. Additionally, the instructions represented by the blocks in FIGS. 5-8 are not required to be performed in the order illustrated, and that all the processing represented by the blocks may not be necessary to practice the invention.

FIG. 9 is a block diagram of one embodiment of a secure transaction system, which may be used in electronic commerce. This secure transaction system may be used to provide a customized service to a user based upon the results of an automatic query of a data structure. In this embodiment, a transaction privacy clearing house (TPCH) 340 interfaces a user (consumer) 940 and a vendor 925. In this particular embodiment, a personal transaction device (PTD) 970, e.g., a privacy card 905, or a privacy card 905 coupled to a digital wallet 950, is used to maintain the privacy of the user while enabling the user to perform transactions. In an alternate embodiment, the PTD 970 may be any suitable device that allows unrestricted access to TPCH 340. The personal transaction device information is provided to the TPCH 340 that then indicates to the vendor 925 and the user 940 approval of the transaction to be performed.

In order to maintain confidentiality of the identity of the user 940, the transaction device information does not provide user identification information. Thus, the vendor 925 or other entities do not have user information but rather transaction device information. The TPCH 340 maintains a secure database of transaction device information and user information. In one embodiment, the TPCH 340 interfaces to at least one financial processing system 920 to perform associated financial transactions, such as confirming sufficient funds to perform the transaction, and transfers to the vendor 925 the fees required to complete the transaction. In addition, the TPCH 340 may also provide information through a distribution system 930 that, in one embodiment, can provide a purchased product to the user 940, again without the vendor 925 knowing the identification of the user 940. In an alternate embodiment, the financial processing system 920 need not be a separate entity but may be incorporated with other functionality. For example, in one embodiment, the financial processing system 920 may be combined with the TPCH 340 functionality.

In one embodiment, the financial processing system (FP) 920 performs tasks of transferring funds between the user's account and the vendor's account for each transaction. In one embodiment, the presence of the TPCH 340 means that no details of the transactions, other than the amount of the transactions and other basic information, are known to the FP 920. The TPCH 340 issues transaction authorizations to the FP 920 function on an anonymous basis on behalf of the user over a highly secure channel. The FP 920 does not need to have many electronic channels receiving requests for fund transfer, as in a traditional financial processing system. In one embodiment, a highly secure channel is set up between the TPCH 340 and the FP 920; thus, the FP 920 is less vulnerable to spoofing.

In one embodiment, the FP 920 is contacted by the TPCH 340 requesting a generic credit approval of a particular account. Thus the FP 920 receives a minimal amount of information. In one embodiment, the transaction information, including the identification of goods being purchased with the credit need not be passed to the FP 920. The TPCH 340 can request the credit using a dummy charge ID that can be listed in the monthly credit statement sent to the user, so that the user can reconcile his credit statement. Further, the personal transaction device 970 can include functionality to cause the credit statement to convert the dummy charge ID back to the transactional information so that the credit statement appears to be a conventional statement that lists the goods that were purchased and the associated amount charged.

A display input device 960 (shown in phantom) may be included to enable the user, or in some embodiments the vendor 925, to display status and provide input regarding the PTD 970 and the status of the transaction to be performed.

In yet another embodiment, an entry point 910 interfaces with the personal transaction device 970 and also communicates with the TPCH 340. The entry point 910 may be an existing (referred to herein as a legacy POS terminal) or a newly configured point of sale (POS) terminal located in a retail environment. The user 940 uses the PTD 970 to interface to the POS terminal in a manner similar to how credit cards and debit cards interface with POS terminals. The entry point 910 may also be a public kiosk, a personal computer, or the like.

The system described herein also provides a distribution functionality 930 whereby products purchased via the system are distributed. In one embodiment, the distribution function 930 is integrated with the TPCH 340 functionality. In an alternate embodiment, the distribution function 930 may be handled by a third party. Utilizing either approach, the system ensures user privacy and data security. The distribution function 930 interacts with the user through PTD 970 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 970 to change the shipping address of the product at any time during the distribution cycle.

A user connects to and performs transactions with an a secure transaction system (such as shown in FIG. 9) through a personal transaction device (PTD) that has a unique identifier (ID). In one embodiment, a privacy card is used. In an alternate embodiment a digital wallet is used. In yet another alternate embodiment, a privacy card in conjunction with a digital wallet is used.

One embodiment of a privacy card 1005 is illustrated in FIG. 10. In one embodiment, the card 1005 is configured to be the size of a credit card. The privacy card includes a processor 1010, memory 1015 and input/output logic 1020. The processor 1010 is configured to execute instructions to perform the functionality herein. The instructions may be stored in the memory 1015. The memory is also configured to store data, such as transaction data and the like. In one embodiment, the memory 1015 stores the transaction ID used to perform transactions in accordance with the teachings of the present invention. Alternately, the processor may be replaced with specially configured logic to perform the functions described here.

The input/output logic 1020 is configured to enable the privacy card 1005 to send and receive information. In one embodiment, the input/output logic 1020 is configured to communicate through a wired or contact connection. In another embodiment, the input/output logic 1020 is configured to communicate through a wireless or contactless connection. A variety of communication technologies may be used.

In one embodiment, a display 1025 is used to generate bar codes scanable by coupled devices and used to perform processes as described herein. The privacy card 1005 may also include a magnetic stripe generator 1040 to simulate a magnetic stripe readable by devices such as legacy POS terminals.

In one embodiment, biometric information, such as fingerprint recognition, is used as a security mechanism that limits access to the card 1005 to authorized users. A fingerprint touch pad and associated logic 1030 is therefore included in one embodiment to perform these functions. Alternately, security may be achieved using a smart card chip interface 1050, which uses known smart card technology to perform the function.

Memory 1015 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 1015 can also have user identity/account information block. The user identity/account information block stores data about the user and accounts that are accessed by the card. The type of data stored includes the meta account information used to identify the account to be used.

One embodiment of a digital wallet 1105 is illustrated in FIG. 11. The digital wallet 1105 includes a coupling input 1110 for the privacy card 1005, processor 1115, memory 1120, input/output logic 1125, display 1130 and peripheral port 1135. The processor 1115 is configured to execute instructions, such as those stored in memory 1120, to perform the functionality described herein. Memory 1120 may also store data including financial information, eCoupons, shopping lists and the like. The digital wallet may be configured to have additional storage. In one embodiment, the additional storage is in a form of a card that couples to the device through peripheral port 1135.

In one embodiment, the privacy card 1005 couples to the digital wallet 1105 through port 1110; however, the privacy card 1005 may also couple to the digital wallet 1105 through another form of connection including a wireless connection.

Input/output logic 1125 provides the mechanism for the digital wallet 1105 to communicate information. In one embodiment, the input/output logic 1125 provides data to a point-of-sale terminal or to the privacy card 1005 in a pre-specified format. The data may be output through a wired or wireless connection.

The digital wallet 1105 may also include a display 1130 for display of status information to the user. The display 1130 may also provide requests for input and may be a touch sensitive display, enabling the user to provide the input through the display.

The physical manifestation of many of the technologies in the digital wallet 1105 will likely be different from those in the privacy card 1005, mainly because of the availability of physical real estate in which to package technology. Examples of different physical representations would include the display, fingerprint recognition unit, etc.

The components of a secure transaction system illustrated in FIGS. 9, 10, and 11 are further described in PCT published patent application number US00/35619, which is assigned to the same assignee as the present application and which is hereby incorporated by reference.

In the foregoing specification, the invention has been described with reference to specific exemplary embodiments thereof. It will be evident that various modifications may be made thereto without departing from the scope of the invention as set forth in the following claims. For example, those of ordinary skill within the art will appreciate that while the invention has been described in terms of a home environment, a services device located in a retail environment could also detect and query the user device to present customized services to the user. The specification and drawings are, accordingly, to be regarded in an illustrative sense rather than a restrictive sense.

What is claimed is:

1. A method of customizing a service provided through a personal service device comprising:
automatically querying a user device in response to discovering the user device;
receiving data from the user device in response to the querying; and
providing the service customized according to the data.

2. The method of claim 1 further comprising:
periodically transmitting a device locator signal to discover user devices.

3. The method of claim 2 further comprising:
receiving identification information from the user device in response to the device locator signal; and
searching identification information for previously discovered devices for a match for the user device.

4. The method of claim 3, where in the querying is performed only for a newly discovered user device.

5. The method of claim 3, wherein the identification information does not include an identity of a user of the user device.

6. The method of claim 1 further comprising:
receiving directory information for the data from the user device.

7. The method of claim 1, wherein the service is customized using a heuristic algorithm.

8. The method of claim 1 further comprising:
combining the data received from multiple user devices.

9. The method of claim 8 further comprising:
if the data received from multiple user devices is conflicting, customizing the service using the data that is most restrictive.

10. The method of claim 8 further comprising:
if the data received from multiple user devices is conflicting, customizing the service based on a manual selection of options.

11. The method of claim 1 further comprising:
sending the data to a server, wherein the service is customized at the server.

12. The method of claim 11, wherein the server is a remotely connected transaction privacy clearing house (TPCH).

13. The method of claim 11, wherein the server is a headend associated with a home network.

14. The method of claim 1 further comprising:
authorizing sending the data by the user device.

15. The method of claim 14, wherein the authorizing is based on a security level for the data.

16. The method of claim 14, wherein the authorizing is based on a certificate received by the user device.

17. The method of claim 16 further comprising:
requesting verification of certificate authenticity from a verification entity by the user device.

18. A computer-readable medium having executable instructions to cause a computer to perform a method comprising:
automatically querying a user device in response to discovering the user device;
receiving data from the user device in response to the querying; and
providing a service customized according to the data.

19. The computer-readable medium of claim 18, wherein the method further comprises:
periodically transmitting a device locator signal to discover user devices.

20. The computer-readable medium of claim 19, wherein the method further comprises:
receiving identification information from the user device in response to the device locator signal; and
searching identification information for previously discovered devices for a match for the user device.

21. The computer-readable medium of claim 18, wherein the method further comprises:
querying only a newly discovered user device.

22. The computer-readable medium of claim 18, wherein the method further comprises:
receiving directory information for the data from the user device.

23. The computer-readable medium of claim 18, wherein the method further comprises: customizing the service using a heuristic algorithm.

24. The computer-readable medium of claim 18, wherein the method further comprises:
combining the data received from multiple user devices.

25. The computer-readable medium of claim 24, wherein the method further comprises:
if the data received from multiple user devices is conflicting, customizing the service using the data that is most restrictive.

26. The computer-readable medium of claim 24, wherein the method further comprises:
if the data received from multiple user devices is conflicting, customizing the service based on a manual selection of options.

27. The computer-readable medium of claim 18, wherein the method further comprises:
sending the data to a server, wherein the service is customized at the server.

28. A computer system comprising:
a processor coupled to a memory through a bus;
a input/output interface coupled to the processor through the bus; and
a personal service device process executed from the memory by the processor to cause the processor to automatically query a user device in response to discovering the user device, receive data from the user device in response to the querying, and provide a service customized according to the data.

29. The computer system of clam 28, wherein the personal service device process further causes the processor to periodically transmit a device locator signal to discover user devices.

30. The computer system of claim 29, wherein the personal service device process further causes the processor to receive identification information from the user device in response to the device locator signal and to search identification information for previously discovered devices for a match for the user device.

31. The computer system of claim 28, wherein the personal service device process further causes the processor to automatically query only a newly discovered user device.

32 The computer system of claim 28, wherein the personal service device process further causes the processor to receive directory information for the data from the user device.

33. The computer system of claim 28, wherein the personal service device process further causes the processor to customize the service using a heuristic algorithm.

34. The computer system of claim 28, wherein the personal service device process further causes the processor to combine the data received from multiple user devices.

35. The computer system of claim 34, wherein the personal service device process further causes the processor to customize the service using the data that is most restrictive if the data received from multiple user devices is conflicting.

36. The computer system of claim 34, wherein the personal service device process further causes the processor to customize the service based on a manual selection of options if the data received from multiple user devices is conflicting.

37. The computer system of claim 28, wherein the personal service device process further causes the processor to send the data to a server, wherein the service is customized at the server.

38. A method of communicating data to a personal service device to customize a service comprising:
receiving a query from the personal service device in response to entering a scanning range of the personal service device;
authorizing data requested by the personal service device; and
sending data to the personal service device if authorized.

39. The method of claim 38 further comprising:
sending identification information to the personal service device.

40. The method of claim 39, wherein the identification information is sent in response to detecting a device locator signal from the personal service device.

41. The method of claim 38, wherein the authorizing is based on a security level for the data.

42. The method of claim 38, wherein the authorizing is based on a certificate received from the personal service device.

43. The method of claim 42 further comprising:
requesting verification of certificate authenticity from a verification entity.

44. A computer-readable medium having executable instructions to cause a computer to perform a method comprising:
receiving a query from a personal service device in response to entering a scanning range of the personal service device;
authorizing data requested by the personal service device; and
sending data to the personal service device if authorized.

45. The computer-readable medium of claim 44, wherein the method further comprises:
sending identification information to the personal service device.

46. The computer readable medium of claim 45, wherein the method further comprises:
sending the identification information in response to detecting a device locator signal from the personal service device.

47. The computer-readable medium of claim 44, wherein the method further comprises:
using a security level for the data to authorize the data.

48. The computer-readable medium of claim 44, wherein the method further comprises:
using a certificate received from the personal service device to authorize the data.

49. The computer-readable medium of claim 48, wherein the method further comprises:
requesting verification of certificate authenticity from a verification entity.

50. A computer system comprising:
a processor coupled to a memory through a bus;
an input/output interface coupled to the processor through the bus; and
a user device process executed from the memory by the processor to cause the processor to receive a query from a personal service device in response to entering a scanning range of the personal service device, to authorize data requested by the personal service device, and to send data to the personal service device if authorized.

51. The computer system of claim 50, wherein the user device process further causes the processor to send identification information to the personal service device.

52. The computer system of claim 51, wherein the user device process further causes the processor to send the identification information in response to detecting a device locator signal from the personal service device.

53. The computer system of claim 50, wherein the user device process further causes the processor to authorize the data based on a security level for the data.

54. The computer system of claim 50, wherein the user device process further causes the processor to authorize the data based on a certificate received from the personal service device.

55. The computer system of claim 54, wherein the user device process further causes the processor to request verification of certificate authenticity from a verification entity.
